(19) United States
(12) Patent Application Publication
(10) Pub. No.: US 2018/0369678 A1
(43) Pub. Date: Dec. 27, 2018

(54) System and Apparatus for Sports Training

(71) Applicant: Shane Yang, San Jose, CA (US)

(72) Inventor: Shane Yang, San Jose, CA (US)

(21) Appl. No.: 15/632,295

(22) Filed: Jun. 23, 2017

(51) Int. Cl. A63B 71/06; H04N 5/77; H04N 5/445; G09B 19/00; A63B 69/36; A63B 69/00; A63B 24/00

(52) U.S. Cl. CPC A63B 71/0622; H04N 5/77; H04N 5/44504; G09B 19/0038; A63B 69/36; A63B 69/0002; A63B 2071/0694; A63B 69/00; A63B 2220/806; A63B 2071/0638; A63B 2069/0008; A63B 2225/50; A63B 24/0062

(57) ABSTRACT

A portable training system that allows a user to translate an external reference of correct form into an internal reference through use of a video capture device and strategically placed display device. The system may include a camera that streams video of the user to one or more display devices at or near real time. Software on each display device overlays a set of guides onto a display screen to enable the user to see where and how a current form of the user deviates from a desired form, which allows real time adjustments by the user. Templates of guides may be provided to the user instead of the user having to create the guides.

### BACKGROUND

### Field

Aspects of the present disclosure relate generally to devices for sports training. Specifically, this invention relates to a system and apparatus for real-time training.

### Background

Learning correct form for any activity is often difficult because observation of correct form by a particular person is usually done using a frame of reference that is external to that person. For example, even a non-player or beginner may usually be able to tell the difference between a good and a bad baseball/golf/tennis swing when watching another person. Thus, the problem lies in how to translate this external knowledge of a “good” swing into an internal reference of feeling when ones form is correct and also instills muscle memory. Traditionally, translation from the external frame of reference to the internal frame of reference is provided by a human coach who can identify and then provide feedback to correct form discrepancies. For example, the coach can provide oral feedback as comments or remarks. This translation allows the participant to more effectively train and practice.

Regardless if one is a professional or a novice, achieving consistency in performance is based on proper training that, in turn, creates muscle memory. During actual real-time play, this muscle memory is critical because no outside coaching is available.

It would be desirable to have more effective approaches for training persons in improving their form in a desired activity.

### SUMMARY

Various aspects of the disclosed approach for a system and apparatus for real-time training may be implemented in a compact and portable training system that allows a user to translate an external reference of correct form into an internal reference through use of a video capture device and strategically placed display device. In one aspect of the disclosed approach, the system may include a camera that streams video of the user to one or more display devices at or near real time. Software on each display device overlays a set of guides onto a display screen to enable the user to see where and how a current form of the user deviates from a desired form, which allows real time adjustments by the user.

### BRIEF DESCRIPTION OF THE DRAWINGS

These and other sample aspects of the disclosure will be described in the detailed description that follows, and in the accompanying drawings.

FIG. 1 is a diagram of an arrangement of a camera and a device for capturing and reviewing video, respectively, of a user configured in accordance with various aspects of the system and apparatus for real-time training disclosed herein.

FIG. 2 is an operational/call flow diagram for enabling communication between the camera and the device of FIG. 1 to provide live video streaming from the camera to the device, and to provide instant replaying and saving of video operations on the device within the system and apparatus for real-time training configured in accordance with various aspects of the disclosed invention.

FIG. 3 is a flow diagram of video processing on a device within the system and apparatus for real-time training configured in accordance with various aspects of the disclosed invention.

FIG. 4 is a block diagram for describing instant replaying and saving of video operations on a device within the system and apparatus for real-time training configured in accordance with various aspects of the disclosed invention.

FIG. 5 is an example display of an application on the device of FIG. 1 that a user may utilize to interact with the system and apparatus for real-time training to create swing guides configured in accordance with various aspects of the disclosed invention.

FIG. 6 is a diagram of a wireless camera broadcasting to multiple devices in one aspect of a system and apparatus for real-time training configured in accordance with various aspects of the disclosed invention.

FIG. 7 is an operational/call flow diagram of a communication process between a first device used by a student, a second device used by a coach, and a wireless camera within the system and apparatus for real-time training configured in accordance with various aspects of the disclosed invention.

FIG. 8 is an example display of an application on a device that a user such as a coach may utilize to interact with the system and apparatus for real-time training configured in accordance with various aspects of the disclosed invention.

FIG. 9 is a diagram of a coach transmitting an overlay from a second device to a first device used by a student in the system and apparatus for real-time training configured in accordance with various aspects of the disclosed approach.

FIG. 10 is a top view of a spatial alignment configuration in the system and apparatus for real-time training configured in accordance with various aspects of the disclosed approach.

FIG. 11 is a side view of a spatial alignment configuration with an alignment line overlay in the system and apparatus for real-time training configured in accordance with various aspects of the disclosed approach.

FIG. 12 is a side view of a spatial alignment configuration with an alignment grid overlay in the system and apparatus for real-time training configured in accordance with various aspects of the disclosed approach.

FIG. 13 is an example display of an application on a device that a user may utilize to create and manage templates in the system and apparatus for real-time training configured in accordance with various aspects of the disclosed invention.

FIG. 14 is an example display of the application on the device that a user may utilize to add overlay shapes to a template in the system and apparatus for real-time training configured in accordance with various aspects of the disclosed invention.

FIG. 15 is an example display of the application on the device that a user may utilize to manage templates in the system and apparatus for real-time training configured in accordance with various aspects of the disclosed invention.

FIG. 16 is an example display of the application on the device that a user may utilize to import templates in the system and apparatus for real-time training configured in accordance with various aspects of the disclosed invention.

FIG. 17 is an example display of the application on the device in the system and apparatus for real-time training where one or more angles of overlay shapes are displayed as configured in accordance with various aspects of the disclosed invention.

FIG. 18 is a block diagram illustrating an example of a hardware implementation for an apparatus employing a processing system that may be used in the system and apparatus for real-time training as configured in accordance with various aspects of the disclosed invention.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The detailed description set forth below in connection with the appended drawings is intended as a description of various configurations of a system and apparatus for real-time training and is not intended to represent the only configurations in which any concepts described herein may be practiced. The detailed description that follows includes specific details for providing a thorough understanding of various concepts. However, it will be apparent to those skilled in the art that these concepts may be practiced without these specific details. In some instances, well-known structures and components are shown in block or other types of diagrams in order to avoid obscuring any particular descriptions—and thereby understanding—of such concepts.

As used herein, the term “form” refers to shape and motion of human movement in order to accomplish an activity. Specifically, in the context of the description, the term refers to a set of positions needed to accomplish a physical activity. Proper form generally results in more power, greater precision, improved efficiency and higher performance for any given activity. For purpose of the various examples used herein, an optimal form for execution of a golf swing by the user may be used. Thus, postures and movement that the user may internalize may be a golf swing.

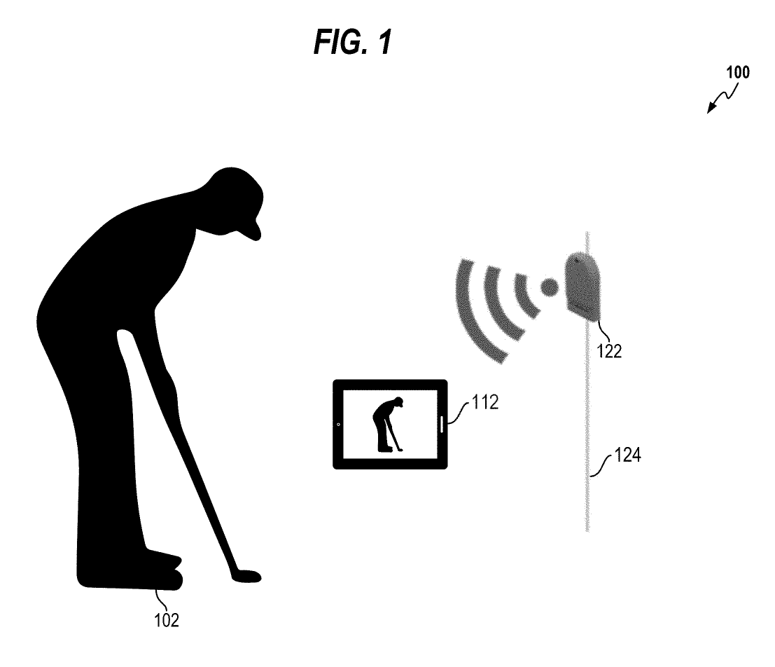

FIG. 1 illustrates arrangement 100 in which various aspects of the system and apparatus for real-time training may be described. The arrangement 100 includes a camera 122 mounted on a support 124 that streams video captured of a user 102 to a device 112. The camera 122 may be implemented by a wireless camera that may be configured to capture movements of the user 122. The device 112 may be any device that includes a display and a communications interface that may connect to the camera 122, as further described herein. Examples of possible devices include smart phone, tablet, and computers.

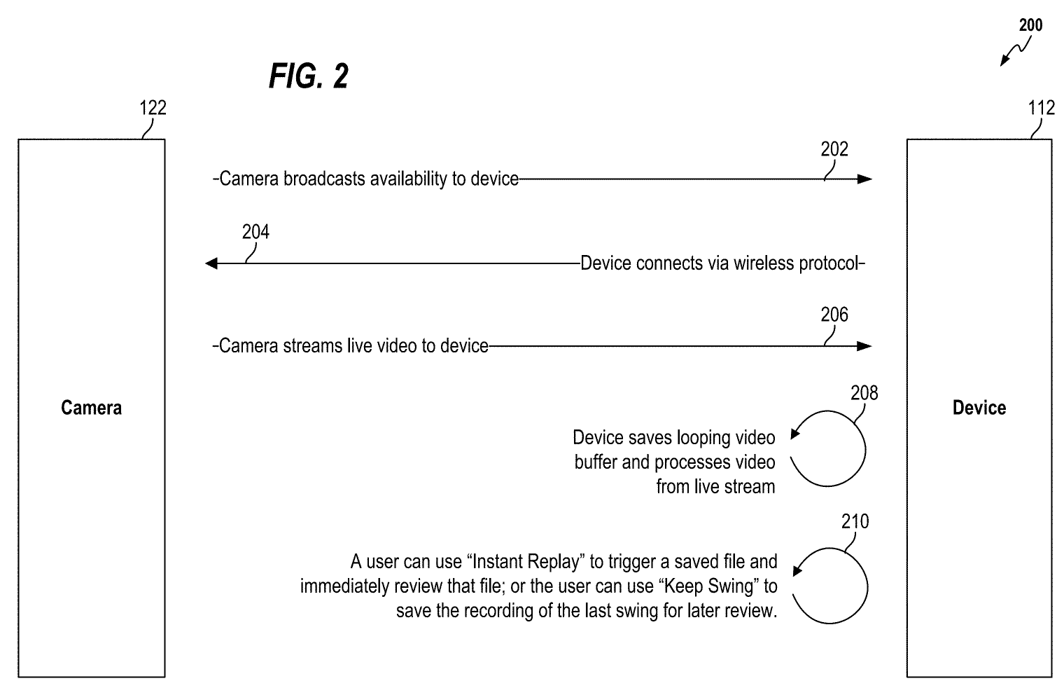

FIG. 2 illustrates a call flow process 200 configured in accordance with various aspects of the system and apparatus for real-time training that describes various operations involving a camera and a device such as the camera 122 and the device 112 of FIG. 1, such as a communication set up operation to allow streaming of video captured of a user such as the user 102 by the camera 122 to the device 112. The call flow process 200 also describes operations provided by the device 112 to allow the user 102 to accessing instant replays of captured video as well as saving of desired video segments.

At 202, the camera 122 broadcasts availability to the device 112. In one aspect of the disclosed approach, the camera 112 may operate as a Wi-Fi hotspot and may be discovered by devices looking for an access point. In another aspect of the disclosed approach, the camera 112 may be available using a different wireless protocol that provides device discovery and sufficient bandwidth and latency to allow image and/or video transfer.

At 204, the device 112 may connect with the camera 122 via a suitable wireless protocol. If the camera 122 is operating as a Wi-Fi hotspot, then the device 112 may connect to the wireless network managed by the camera 122. The camera 122 may require the device 112 to provide a valid password before being allowed to join the wireless network.

At 206, the camera 122 begins to stream video in real time to the device 112. In accordance with various aspects of the disclosed approach, the camera 122 may employ any particular streaming protocol or standard to send video to the device 112. Further, instead of transmitting video, a series of images may be transferred. Preferably, any approach of transmitting images or video at a frame rate sufficiently high enough to allow useful analysis of the form of the user 102 should be implemented.

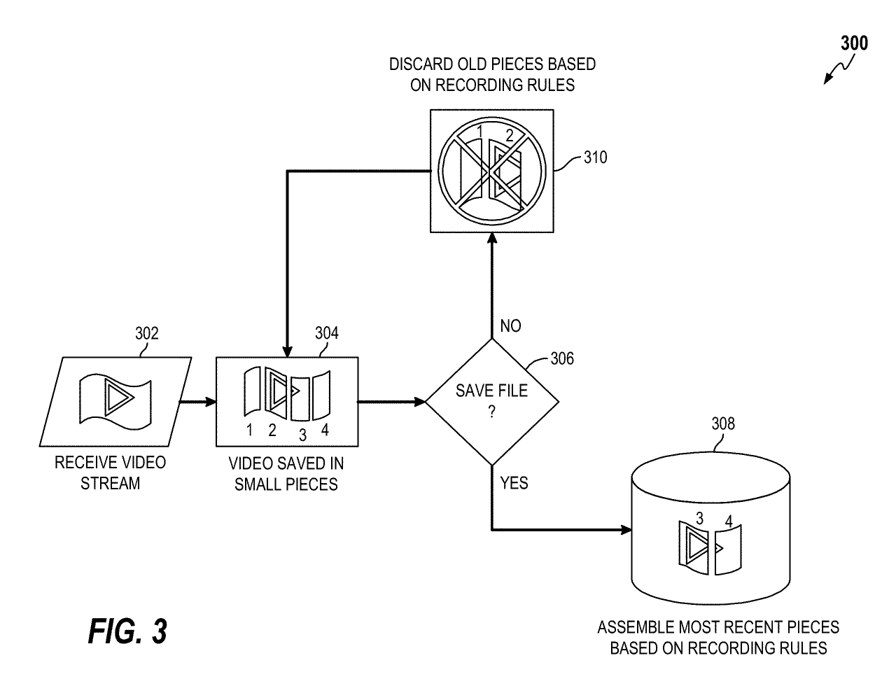

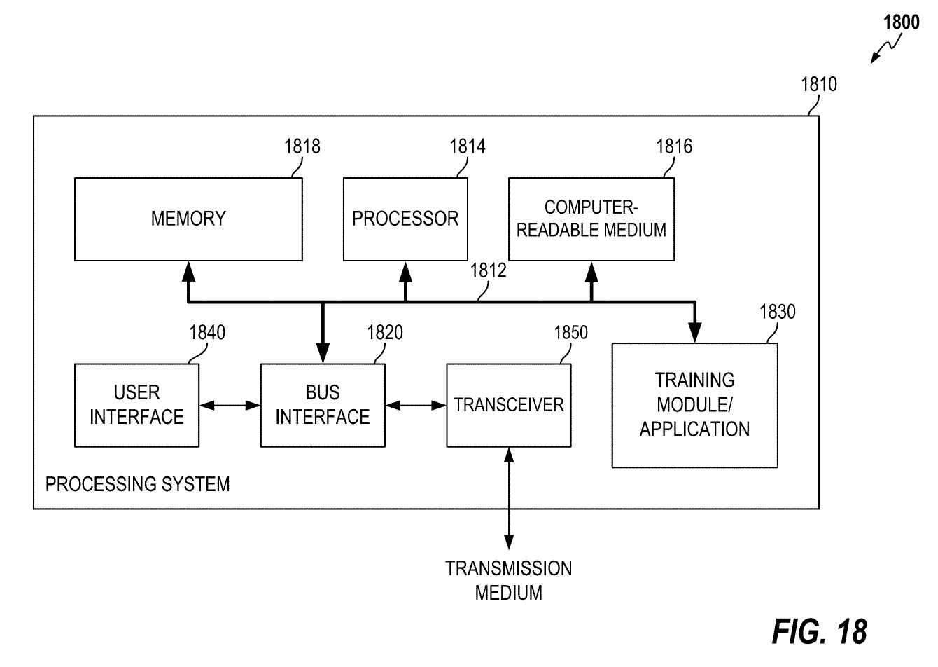

At 208, the device 112 may utilize a video buffer to process the video from the live stream. Details of the video buffer are described further herein with reference to FIG. 18, while FIG. 3 illustrates a video processing process 300 in the device 112 configured in accordance with various aspects of the disclosed approach where, at 302, a video stream is received from the camera 122. The term “video stream” as used herein refers to a series of images that make up a video. As used herein, the term “video” may thus refer to a single image (i.e., a video with a single frame) or a series of images (i.e., a video with a number of frames), and those of ordinary skill in the art would understand when one or both references applies.

At 304, the video stream received from the camera 122 is segmented into samples of a predetermined size. The term “sample” as used herein also refers to a series of images that make up a video, but when used in context with the term “video stream,” a sample generally refers to a subset of the series of images (i.e., a segment of video) from the video stream. One or more samples may be assembled to create a larger sample. In other words, one or more video segments may be assembled together to create larger video segments.

At 306, it is determined if samples of the video stream should be saved. If samples of the video stream should be saved, then operation continues at 308. Otherwise, operation continues at 306.

At 306, where it has been determined that not all samples of the video stream should be saved, one or more samples may be discarded. The discarded samples frees up space in the video buffer for storing more samples from the video stream. An example shown in the figure is where samples 1 and 2 are discarded.

At 308, where it has been determined that one or more samples of the video stream should be saved, these samples are assembled to create a video that may be saved. In one aspect of the disclosure, these one or more samples of the video stream may be saved in a storage such as the storage 432.

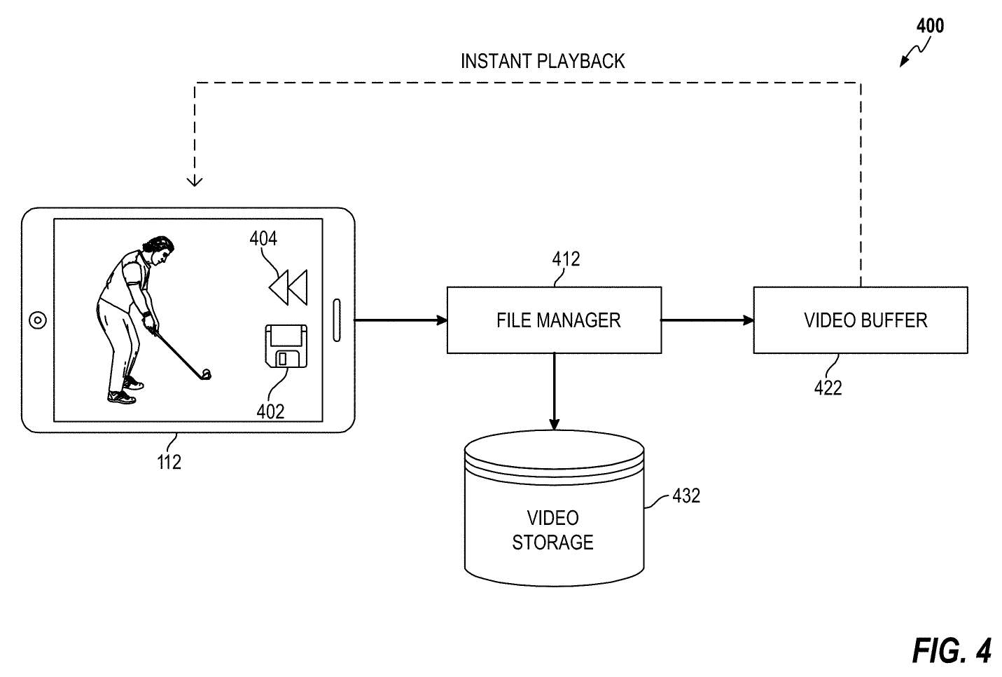

Continuing to refer to FIG. 2 while also referring to FIG. 4, which illustrates how instant replay and keep swing operations may be implemented with a file management configuration 400 on a device such as the device 112 within the system and apparatus for real-time training configured in accordance with various aspects of the disclosed approach, at 210, the user 102 may use an “Instant Replay” button 404 on the display of the device 112 to immediately review a video of the last swing. The user 102 may use a “Keep Swing” button 402 on the display of the device 112 to save the recording of the last swing for later review.

A file manager 412 manages long term storage of video in a storage 432 and temporary storage of video in a video buffer 422. In accordance with one aspect of the disclosed approach, a user may save video in the storage 432 using the “Keep Swing” button 402 on the display of the device 112. In addition, the video buffer 422 may be used to provide video for instant playback when the “Instant Replay” button 404 on the display of the device 112 is used.

In addition to displaying video from the camera 122 as described above, the display on the device 112 of FIG. 1 may include a graphical overlay of one or more guides, referred to as “swing guides,” for helping the user establish proper form. As shown, a swing guide may be implemented by a graphical object such as a line.

Swing guides assist a user in learning correct form by providing simple visual guides, superimposed on a live video feed of the user, on a display that may be placed in a visual range of the user, to follow during practice. By following swing guides during practice, the user is able to build muscle memory and internalize correct form. For example, as further described herein, the user 102 may use the device 112 to view a swing guide superimposed on the live video feed from the camera 122 to adjust his own form and, through repetition, positively ingrain a feel for the correct form to build muscle memory for use during actual play.

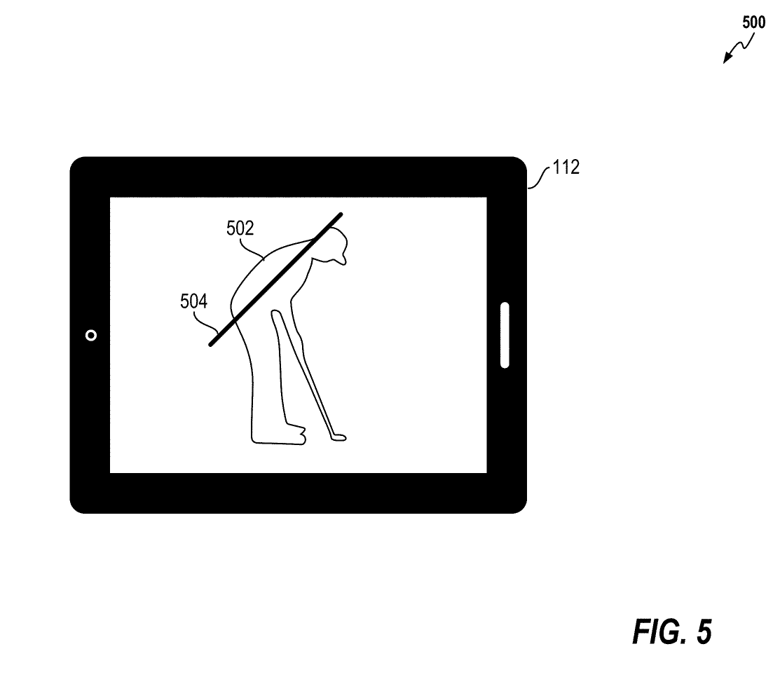

In one aspect of the disclosed approach, swing guides may be created by a user during review of a live video stream. FIG. 5 illustrates an example display 500 of an application on a device such as the device 112 that a user such as the user 112 may utilize to interact with the system and apparatus for real-time training configured in accordance with various aspects of the disclosed approach to create swing guides. The example display 500 includes an image 502 of the user 102. The example display 500 further includes a swing guide 504 that the user 102 has drawn (i.e., a mark-up of the image shown on the example display 500). Although multiple swing guides may be drawn, only a single swing guide is shown to avoid overly complicating the description.

Swing guides may also be created based on review and mark-up of other video sources such as preexisting videos or photos. For example, the image shown on the example display may be from a recorded video (whether the recorded video is from an Instant Replay operation or a Keep Swing operation) as opposed to being from the live stream. Thus, the user may utilize software on the device 112 to review a recorded video. This video may show the form of the user to be corrected, or a model form to be used as reference. During viewing of the video, the user may draw digital objects corresponding to specific areas of improvement on the device. These digital objects and their relative positions on the screen are stored in a drawing file corresponding to the matching video, as further described herein.

In addition to storing drawing files along with matched videos, in one aspect of the disclosed approach a drawing file for the live video stream, referred to as “a live video drawing file”, may also be maintained. The live video drawing file functions similarly to the recording drawing files and has the same file structure. Thus, the live video drawing file may be transparently overlaid on the live video, just like the recorded video drawing files. The live video drawing file may be locked for edits or remain editable. The main differences between recorded video drawing files and the live video drawing file are: (1) the live video drawing file is empty when the software starts, and (2) the live video drawing file may copy data from recorded video drawing files to quickly acquire a full set of precisely placed objects for review during practice. Updates to the live video drawing file may occur automatically when opening a recorded video, or manually at the request of the user. Because this live video drawing file is visible to the user in the live mode for practicing their swing, the live video drawing file may be thought of as containing “live swing guides.” It should be noted that effectively, live video drawing files are just drawing files and the terminology used herein is intended for explanation of the various aspects.

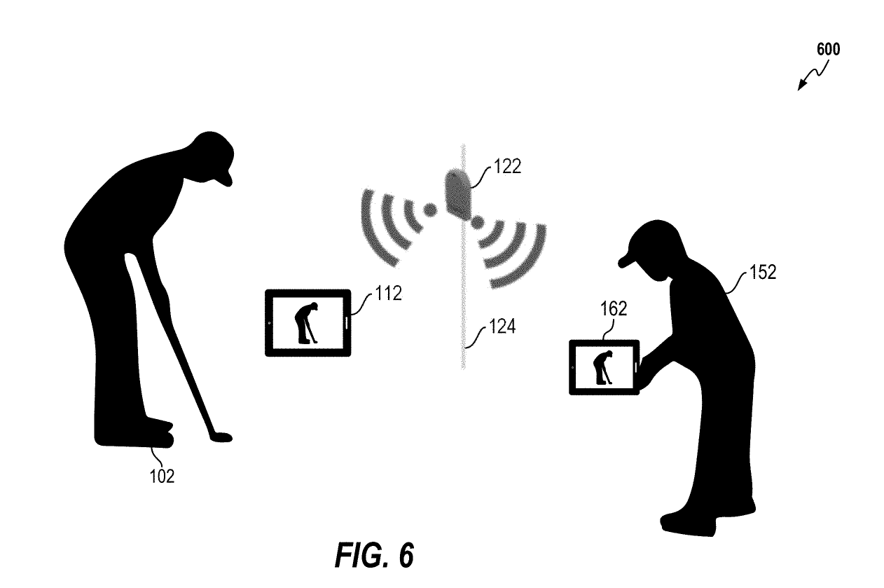

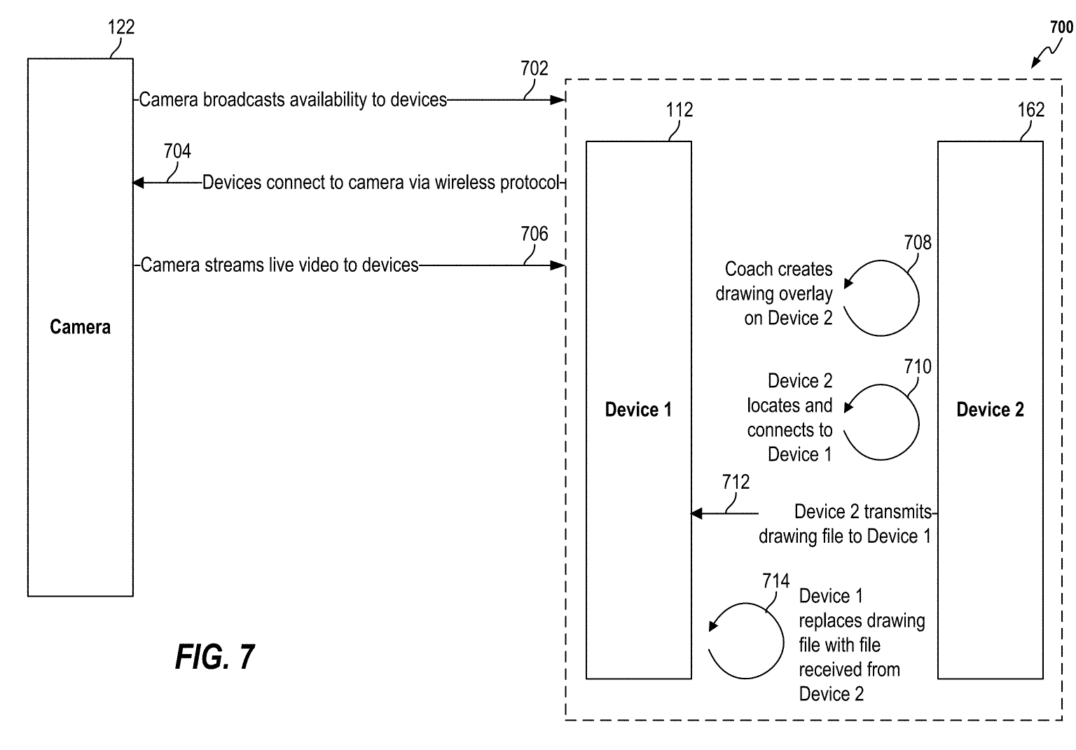

In one aspect of the disclosed approach, instead of a user such as the user 102 creating swing guides, another user such as a coach may create swing guides on another device receiving the same live video stream. FIG. 6 illustrates an arrangement 600 in which various aspects of the system and apparatus for real-time training may be described for a coaching session where another user such as a coach 152 may draw in swing guides while observing a live video feed of a student such as the user 102. In describing the arrangement 600, reference will also be made to FIG. 7, which illustrates a call flow process 700 to enable a camera such as the camera 122 to broadcast video to multiple devices, including a first device such as the device 112 used by the user 102, and a second device such as a device 162 used by the coach 152.

In accordance with various aspects of the disclosed approach described herein, it should be noted that the interaction between the coach 152 and the device 162 may be understood as described for the user 112 and the device 122. Thus, unless otherwise noted, all functionality and operations described for the device 122 should be understood to apply to the device 162. For example, in addition to displaying the live stream of the user 112, the device 162 allows the coach 152 to access instant replays of captured video as well as saving of desired video segments, as well as create swing guides.

In addition to providing a description similar to the call flow process 200 described in FIG. 2, which describes a communication set up operation to allow streaming of video captured of the user 102 by the camera 122 to the device 112, the call flow process 700 further describes a communication set up operation to also allow streaming of video captured of the user 102 by the camera 122 to the device 162. The call flow process 700 also describes how a swing guide created by the coach 152 on the device 162 may be transferred to the device 112.

At 702, the camera 122 broadcasts availability to the device 112 and the device 162. In one aspect of the disclosed approach, the camera 112 may operate as a Wi-Fi hotspot and may be discovered by devices looking for an access point. In another aspect of the disclosed approach, the camera 112 may be available using a different wireless protocol that provides device discovery and sufficient bandwidth and latency to allow image and/or video transfer.

At 704, both the device 112 and the device 162 may connect with the camera 122 via a suitable wireless protocol. If the camera 122 is operating as a Wi-Fi hotspot, then the devices may connect to the wireless network managed by the camera 122. The camera 122 may require the devices to provide a valid password before being allowed to join the wireless network.

At 706, the camera 122 begins to stream video in real time to the device 112 and the device 162. In accordance with various aspects of the disclosed approach, the camera 122 may employ any particular streaming protocol or standard to send video to the devices. Further, as previously noted, instead of transmitting video, a series of images may be transferred. Preferably, any approach of transmitting images or video at a frame rate sufficiently high enough to allow useful analysis of the form of the user 102 should be implemented.

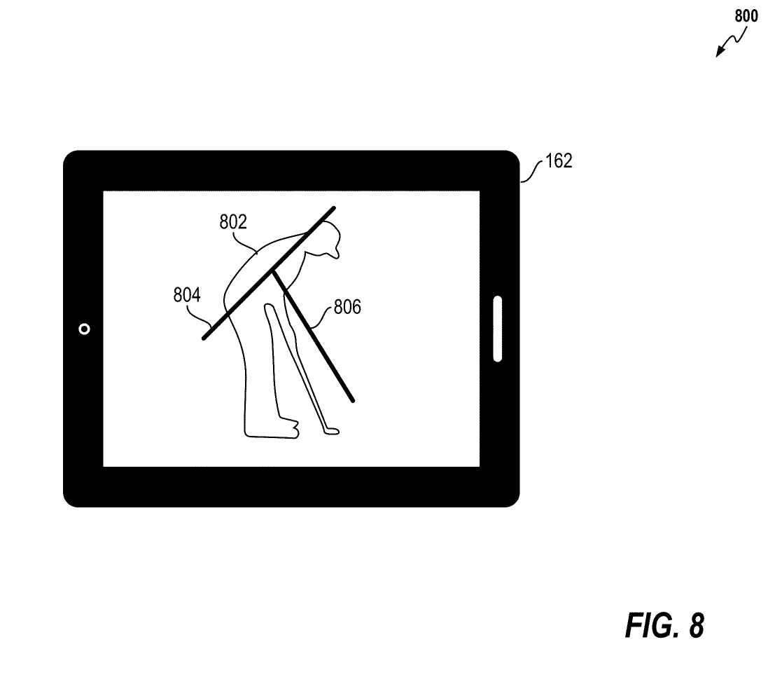

At 708, the coach 152 may use the device 162 to create one or more graphical objects overlays as swing guides for the user 102. FIG. 8 illustrates an example display 800 of an application on a device such as the device 162 that a user such as the coach 152 may utilize to interact with the system and apparatus for real-time training configured in accordance with various aspects of the disclosed approach to create swing guides. The example display 800 includes an image 802 of the user 102. The example display 800 further includes a swing guide 804, which is the swing guide 504 that the user 102 has previously drawn on the device 112, as described with reference to FIG. 5. The example display 800 still further includes a second swing guide 806 as drawn by the coach 152, such as when the coach 152 is reviewing the form of the user 102.

At 710, the device 162 may locate and connect to the device 112 using any available network protocol. In one aspect of the disclosed approach, if the camera 122 operates as a Wi-Fi hotspot and both the device 112 and the device 162 are coupled to the camera 122, then the device 162 should be able to discover the device 112 and a initiate connection to transfer data.

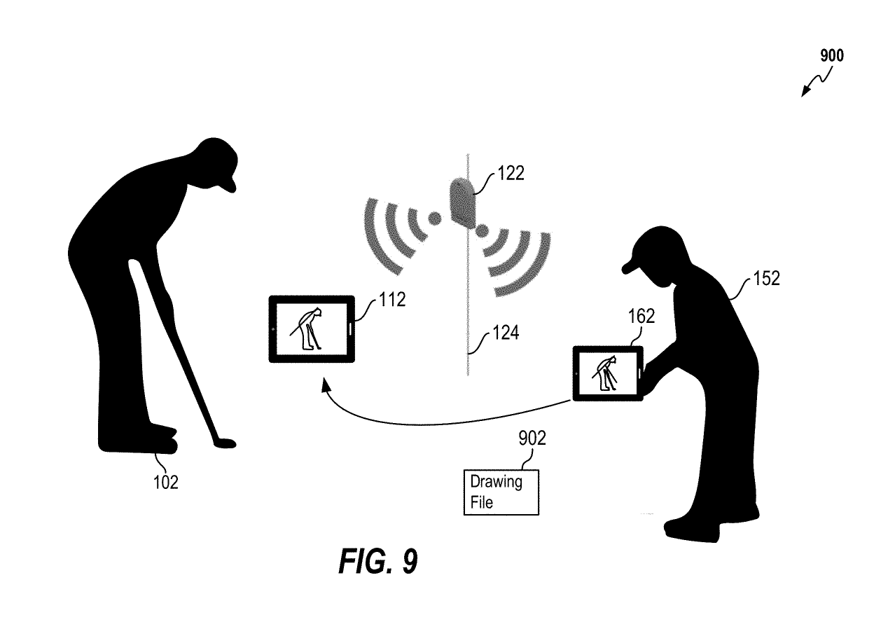

At 712, the device 162 may transmit the updated drawing file from the coach 152 to the device 112. FIG. 9 illustrates transmission of a drawing file 902 from a second device used by a coach to a first device used by a student in the system and apparatus for real-time training configured in accordance with various aspects of the disclosed approach. The figure provides a coaching scenario 900 where the coach 152 using the device 162 may work with a student such as the user 102 to improve the form of the student. The coach 152 may generate a swing guide on the device 162 in accordance with various aspects of the disclosed approach for creating swing guides described herein. The device 162 communicates the drawing file 902 that includes the newly created swing guide, as example of which was discussed as second swing guide 806 in FIG. 8, to the device 112. As described herein, the drawing file 902 may include multiple swing guides.

At 714, the device 112 replaces the drawing file local to the device 112 with the drawing file 902 received from the device 162. In accordance with various aspects of the disclosed approach, although the device 112 may accept such outside swing guides automatically, the device 112 may also request approval from the user 102 prior to accepting the drawing file from the device 162 and updating the display with the new swing guide (second swing guide 806) contained therein.

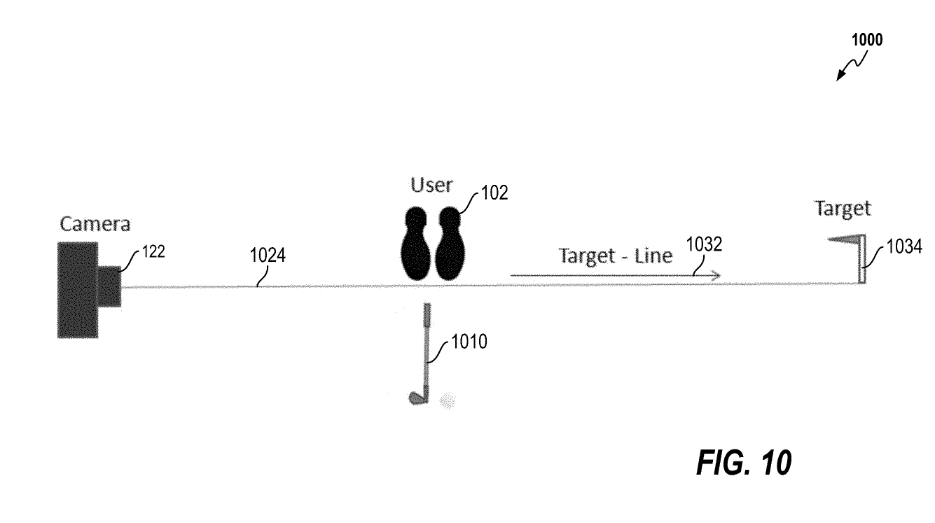

In accordance to various aspects of the disclosed approach, as illustrated by a spatial alignment configuration 1000 in FIG. 10, a spatial relationship between a camera such as the camera 122, a user such as the user 102, and a target 1034 should be established in order to correctly place a swing guide on a display. Because the desired spatial relationship is fixed and the function of the approach is to guide the user to replicate the desired physical set-up of the camera in relation to the user and the target, a main goal is to align the user and the target down a center of a camera using this fixed spatial relationship approach. As the correct positioning of swing guides may be dramatically affected by slight shifts in the 3D perspective of the camera, one of the key functions of the disclosed approach is to establish a clear spatial relationship between the camera 122, the user 102, and the target 1034.

In one aspect of the disclosed approach, to achieve alignment the user 102 may adjust a camera perspective until a center line 1024 of the camera 122, as displayed on a device, matches the target line 1032. This center line 1024 is also a set up line for the user 102 to correctly aim the camera 122 at the target 1034. The alignment lines may be incomplete or transparent in order to minimize the distraction on the user interface.

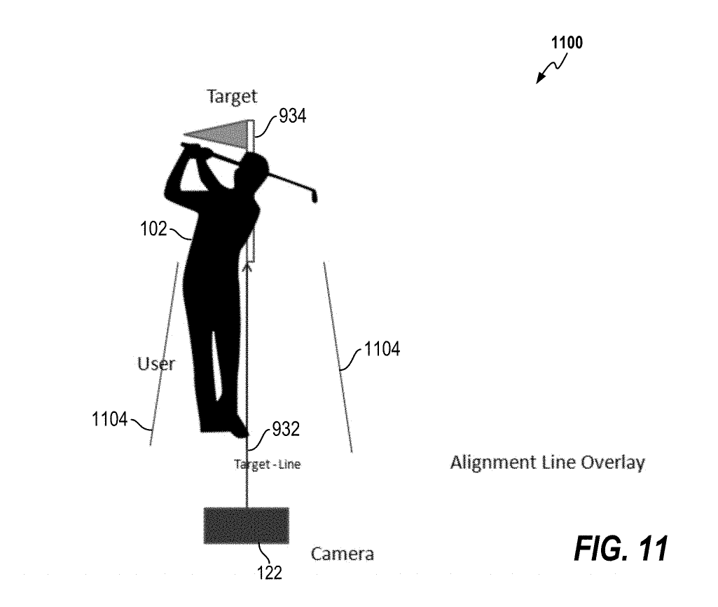

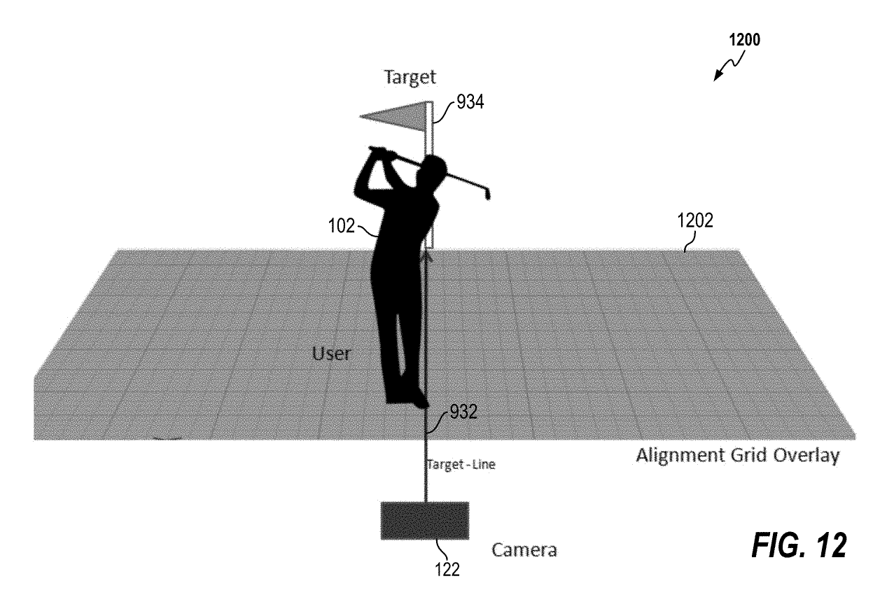

In order to enable the user to correctly align the camera, an alignment display overlay may be used in accordance with one aspects of the disclosed approach. The alignment display overlay may include a grid and/or straight vertical lines matching the optical convergence point of the camera lens. FIG. 11 illustrates a straight line spatial alignment configuration 1100 with the alignment display overlay including an alignment line overlay 1104 configured in accordance with various aspects of the disclosed approach. In one aspect of the disclosed approach, the alignment line overlay 1104 may be incomplete or transparent in order to minimize the distraction on the user interface. FIG. 12 illustrates a grid spatial alignment configuration 1200 with the display overlay including an alignment grid overlay 1202 configured in accordance with various aspects of the disclosed approach. In one aspect of the disclosed approach, the alignment grid overlay 1202 may be incomplete or transparent in order to minimize the distraction on the user interface.

In another aspect of the disclosed approach, a correct spatial alignment may be calculated using 3D rendering techniques. In this approach the user may use the device and software to draw a straight line between the user's stance and the target. Since the field of view of the camera is definitely known and pre-programmed into the software, there are only two additional pieces of information that are necessary in order to determine the location of any point in the field of view of the camera. The first piece of information is the level (left to right) and azimuth of the camera's optical center line. Both of these data points may be acquired by a built-in sensor. The second piece of information is the camera height of the ground. Since, in this special case, the operating parameter is fairly constant, the calculation may assume an approximation of 3 feet. With the field-of-view clearly defined in 3D, it is possible to calculate spatial positioning of any 2 points located on a flat ground surface.

Because, in various aspects of the disclosed approach, a stationary camera configured to establish a useful spatial relationship between the camera and the user is used, the user may create an aligned swing guide by themselves by marking up the recorded file and then matching the specified position of the recording in live practice.

The screen aspect ratio of the device may not match that of the camera (for example 16:9 vs. 3:4). In one aspect of the disclosed approach, the user may shrink or expand the video to take up the entire screen or preserve the original aspect of the video source. Because this resizing will affect the accuracy of the swing guide overlaid on the display, the swing guide must be resized to match the video.

In one aspect of the disclosed approach, the drawing files store additional data regarding the screen aspect of the display at the time the drawing file was generated. When loading a recorded video and matching drawing file, the software will take the additional step of checking the current aspect ratio in use on the display. If the aspect matches the setting in the drawing file, the file can be imported without changes. If the aspect is different, the software will scale the drawing file to the new aspect before applying the overlay to the recording.

When using the swing guide to practice with live video the user may decide to review a recent swing in slow motion that has already completed. Because the user can't always predict which swing would be helpful to review in order to improve the user's form, it is useful to be able to go “back in time” after a swing has already completed to study it more carefully using the recorded playback tools of “slow motion” and “pause” freeze frame.

In one aspect of the disclosed approach, the device records all video as soon as the software is activated and receives a signal from the camera. In order to reduce storage space requirements, the software may utilize a looping buffer, discarding all video older than “T” seconds. “T” may be set by the user in a settings menu. When the user decides to review a swing, the use of a “Replay” button will trigger the software to save the “T” second video buffer and go directly from the live screen to the playback screen for that file, bypassing the normal file selection menu. Any swing guide currently in use will also be saved to the same recording as the accompanying drawing file.

In another aspect of the approach, the software on the device may offer a “save” button. Saving the file will save the same “T” second of video buffer but not trigger the immediate launch of the playback screen. The user may choose to save a swing if they are not sure if they want to review the file.

When practicing a sport like golf, video analysis can be used in order to slow down real time events for easier analysis by the human eye. When such video is taken, there may be a lot of useless footage shot before or after the ball strike. Going through this footage in regular or slow motion is time consuming and distracting, making practice less efficient

When reviewing saved video footage from a buffered recording, the user selected video buffer “T” may be quite large. When T is large there will be a lot of useless footage shot before or after each ball strike. Going through this useless portion of the footage in regular or slow motion is time consuming and distracting, making practice less efficient.

Various aspects of the disclosed approach provide solutions for simplifying and accelerating location of more relevant portions of the footage, such as the moment when the club swung by the golfer strikes the ball. The relevant portion may then be used for more detailed analysis and or examined to provide feedback for the golfer.

Although the actual timing depends on each golfer, a full swing may last a few seconds before and after the moment of impact. In golf, the moment of impact produces a sharp and loud sound. In one aspect of the disclosed approach, audio from a video recording of a particular moment of impact from a swing sequence of a golfer may be used to identify the beginning of the actual swing. Using timing parameters that may be predetermined or customized, video playback may then be set to start prior to a beginning of the swing sequence. For example, video playback may start two seconds before the swing sequence.

In one aspect of the disclosed approach, the audio from the video recording will be analyzed for the moment of impact. Specifically, the sound of impact may be used to locate the moment of playback. A time point associated with the sound of impact is used as an index in the video recording.

In another aspect of the disclosed approach, the time parameters associated with identifying the beginning of the swing sequence may be set to predetermined amounts. For example, once the sound of the impact is identified, that time is stored as an impact time (t_impact), then the start of the playback may be set to a start time (t_start) based a predetermined backoff period (p_backoff). In the example provided above, p_backoff=2 where the video playback starts at two seconds before the sound of impact. Thus, t_start=t_impact−p_backoff.

It should be noted that the various aspects of the disclosed approach may be applied to other sports or activities. For example, in baseball a bat hitting the ball will also have a distinct sound during the moment of impact. Using this approach, it is possible to identify and jump to a beginning of a portion of a relevant event in a video recording, such as a beginning of a swing sequence in a video recording. This will greatly accelerate review of footage for training and learning.

In another aspect of the disclosed approach, instead of a user such as a student or coach having to create swing guides, “swing templates” that are preconfigured with one or more swing guides may be provided. As discussed, a swing guide may be implemented by a graphical object such as a line that may be overlaid on the video. As a swing template may contain more than a single swing guide, each swing template may includes one or more graphical objects, such as one or more lines. Although description of various aspects of the disclosure use a graphical object type such as a line in the examples it should be noted that other types of graphical objects other than lines may be used. For example, ovals, circles, rectangles, squares, and other geometric shapes may be used as swing guides.

In one aspect of the disclosure, swing templates may include information about about each swing guide contained therein, such as size, position, and orientation. In another aspect of the disclosure, swing templates may include relationshional information regarding swing guides contained therein, such as how each swing guide may be sized, positioned, or oriented with respect to other swing guides in a particular swing template. Thus, once loaded, each swing template may be scaled and moved to match up to the current user setup and video feed.

A swing template may be stored in a drawing file that contains actual file/data structures to store the swing template, as discussed herein. The drawing file may include additional header/footer file information. The particular file/data structures format used may be chosen as expedient to one of ordinary skill in the art to implement the various aspects of the disclosure contained herein.

Conceptually, swing templates may be stored in, and then retrieved from a collection of swing templates referred to as a “template library.” The template library may be stored locally on the device or remotely off the device, such as on one or more servers reachable on a network, or both. Thus, storage for the swing templates that make up a particular template library may be distributed across several devices and systems. Explained in terms of drawing files, a template library may be a collection of drawing files that may be stored in a database or a file storage system.

Swing templates offer many benefits. For example, coaches may use swing template and customize any swing guide contained therein for a particular student. In another example, swing templates may be used by the student to practice form without requiring another person such as a coach to create swing guides.

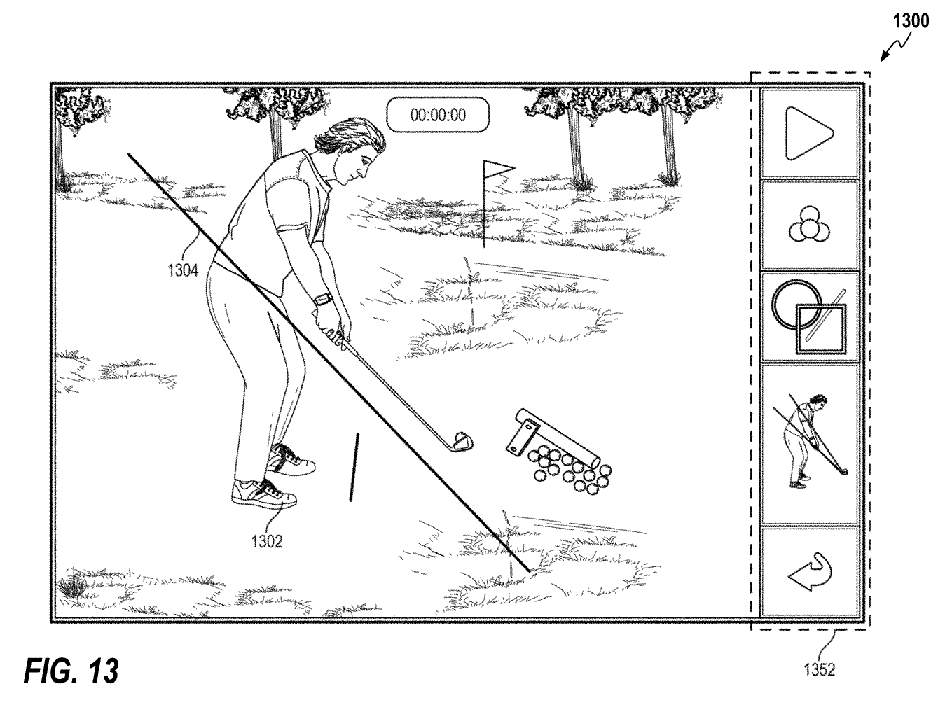

FIG. 13-FIG. 16 may be used to describe various aspects of swing templates, where 13 illustrates an example display 1300 of an application on a device such as the device 112 that a user such as the user 102 may utilize to create and manage swing templates in the system and apparatus for real-time training configured in accordance with various aspects of the disclosure. As illustrated, the user 102 is represented on the display 1300 as a user 1302. A set of icons 1352 on the display 1300 represent tools that may be used by the user 102 to interact with the device 112, which includes a graphical object tools icon and a swing template management icon. The various displays described herein is assumed to have a touch-screen capable interface. The terms “select”, “drag”, “tap”, etc., are to be understood to be user interface actions that may be used to interact with the touch-screen capable interface. Other user interfaces may be used and the examples provided are not meant to be limiting.

Swing templates may be created from a live video stream in one aspect of the disclosed approach. In this aspect, to create a swing template, one or more graphical objects (swing guides) may be drawn by the user while viewing the live video stream. The swing guides are overlaid on the live video stream that is displayed in the same way as swing guides would be during live practice sessions as discussed above. A swing guide 1304 is already illustrated as an example of a graphical object that is a line in the various figures.

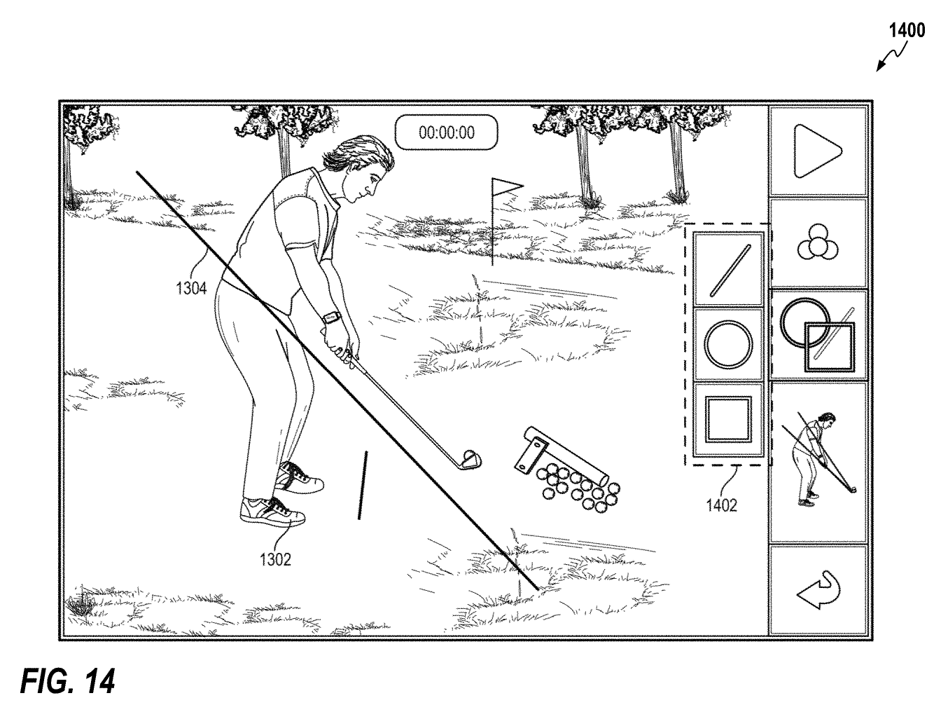

A set of graphical object icons 1402 are shown in FIG. 14, which is an example display 1400 of the application that a user may utilize to add swing guides configured in accordance with various aspects of the disclosed invention. The set of graphical object icons 1402 may be displayed by the user selecting, from the set of icons 1352, a icon made up of a line, an oval, and a rectangle. As illustrated, the set of graphical objects 1402 include a line, an oval, and a rectangle. Each of these may be selected by the user touching the display 1300 and dragged into position. One or more handles (not shown) may be used to manipulate size, orientation, or position of the graphical object.

Preexisting images or videos on which graphical objects may be drawn are loaded during swing template creation in another aspect of the disclosed approach. These preexisting images or videos used to create a swing template are not limited to those captured of a user such as the user 102. For example, these preexisting images or videos may include images or videos of such professionals as Tiger Woods or Phil Mickelson. As another example, these preexisting images may include a photo of someone with a “perfect” form, which may have been captured from a magazine.

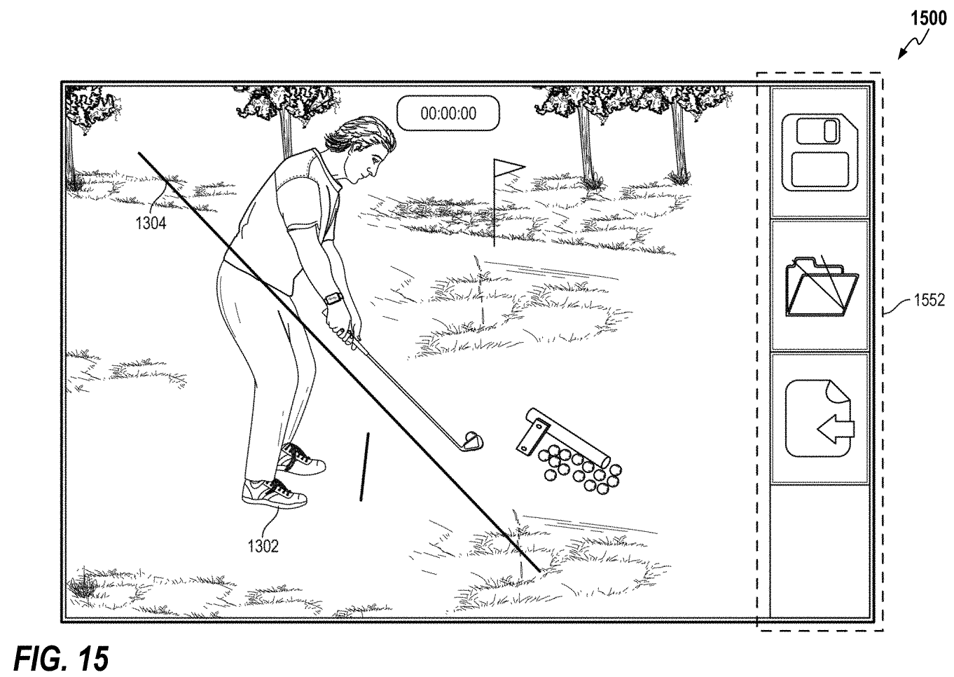

FIG. 15 is illustrates an example display 1500 of the application with a set of template management icons 1552 representing tools that the user may utilize to manage templates in the system and apparatus for real-time training configured in accordance with various aspects of the disclosed invention. The set of template management icons 1552 may be called up from an icon in the set of icons 1352 on the display 1300. Specifically, an icon with a caricature of a person in the set of icons 1352 may be used to call up the set of template management icons 1552. As shown by the display 1500, the set of template management icons 1552 is shown as a submenu that replaces the set of icons 1352 and includes as a swing template creation icon that has a picture of a file with an arrow. The swing template creation icon provides the functionality of importing pictures or video for adding of swing guides to create swing templates, as described above.

As used herein, the terms “load” and “import” may be used interchangeably to refer to retrieval of data from a data source. Similarly, the terms “save” and “export” may be used interchangeably to refer to storage of data into a data sink. These data sources and sinks may include devices such as computer storage media that may or may not be directly connected to a display device such as the device 112 of FIG. 1.

To save the currently configured swing guides in a swing template, a disk icon in the set of template management icons 1552 may be used to store all the swing guides into a drawing file, which may be a new drawing file. An existing drawing file may be updated as described herein. Thus, the user may save altered line set as new template or, alternatively, the altered swing guides may be used to update one or more of the templates used in the creation of the new template.

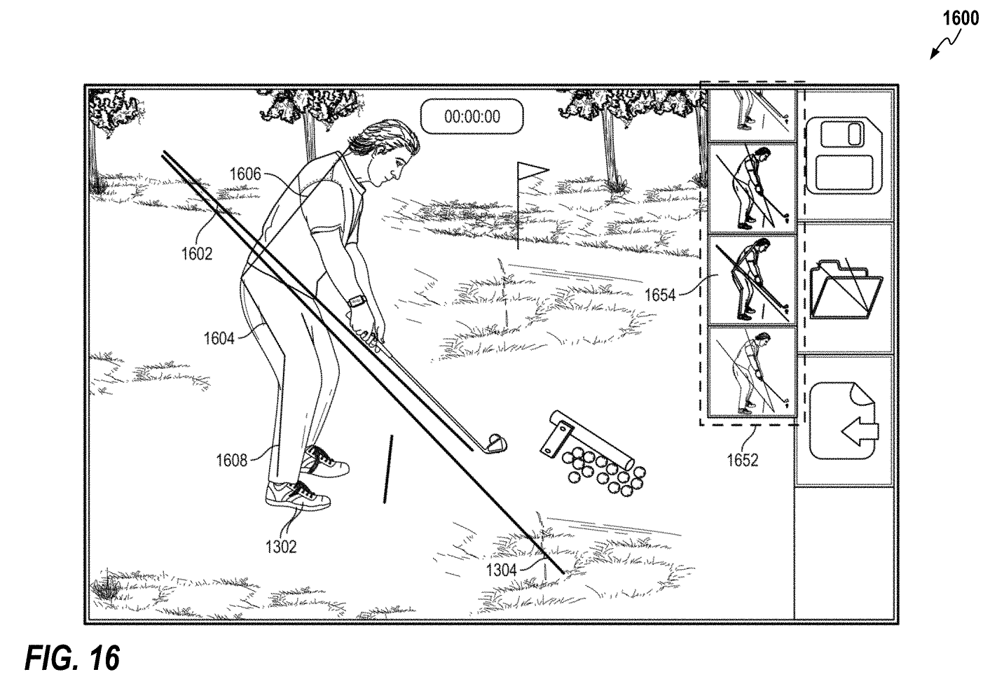

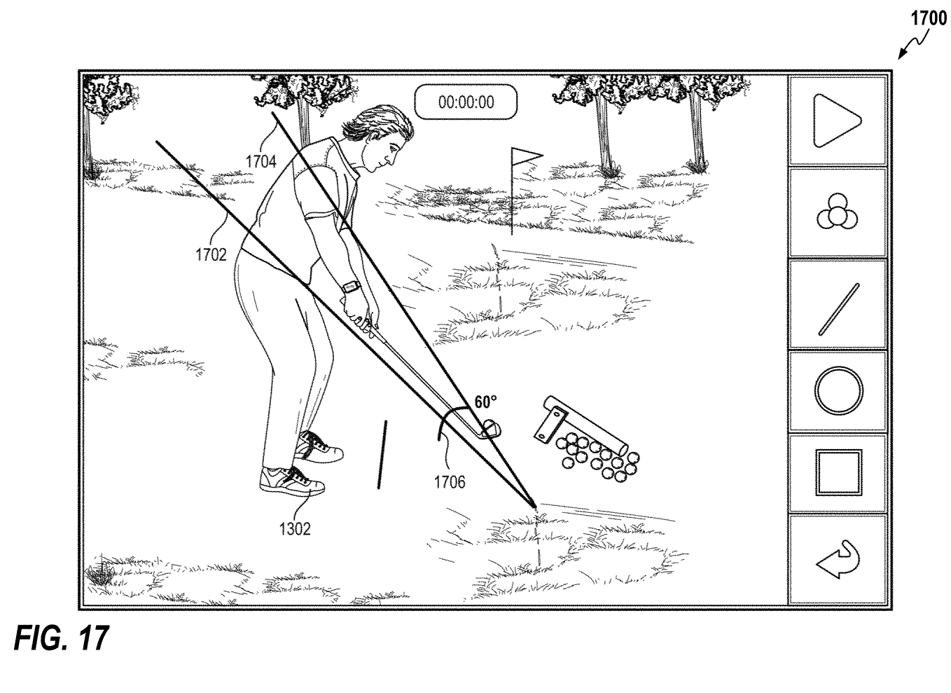

The set of template management icons 1552 also includes a swing template library to access existing swing templates that may be imported. FIG. 16 is an example display 1600 of the application on the device that a user may utilize to import templates in the system and apparatus for real-time training configured in accordance with various aspects of the disclosed invention, where a set of swing guides 1602, 1604, 1608 are loaded from a template 1654 in a set of templates 1652 that may be imported. Multiple templates may be imported as each template contains a set of swing guides. The swing guides from each template may be overlaid on top of loaded images or videos. The swing guides may be adjusted. Specifically, the imported swing guides may be moved and scaled. As the swing guides are adjusted, the angles between lines may be shown. FIG. 17 is an example display 1700 of the application on the device in the system and apparatus for real-time training where one or more angles 1706 of a set of swing guides 1702 and 1704 overlaid on the display 1700 are displayed as configured in accordance with various aspects of the disclosed invention.

Generally, in accordance with various aspects of the disclosure, in terms of creating a swing template, new graphical objects may be drawn as swing guides. Then, these swing guides in these swing templates may be adjusted. Thereafter, the swing template is saved.

FIG. 18 is a conceptual diagram illustrating an example of a hardware implementation for an apparatus 1800 employing a processing system 1810 that may be used in the system and apparatus for real-time training. For example, a combination of elements in the apparatus 1800 may be used to implement a device such as the device 112 or the device 162. In addition, a combination of elements in the apparatus 1800 may be used to implement a camera such as the camera 122.

For example, the processing system 1810 includes one or more processors illustrated as a processor 1814. Examples of processors 1814 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processing system 1810 may be implemented as having a bus architecture, represented generally by a bus 1812. The bus 1812 may include any number of interconnecting buses and bridges depending on the specific application of the processing system 1810 and overall design constraints. The bus 1812 links together various circuits including one or more processors (represented generally by the processor 1814), a memory 1818, computer-readable media (represented generally by a computer-readable medium 1816), and a training module/app 1830. The bus 1812 may also link various other circuits such as timing sources, peripherals, voltage regulators, and power management circuits, which are well known in the art, and therefore, will not be described any further. A bus interface 1820 provides an interface between the bus 1812 and a transceiver 1850. The transceiver 1850 provides a means for communicating with various other apparatus over a transmission medium. Depending upon the nature of the apparatus, a user interface 1840 (e.g., touch-screen display or other types of display, keypad, speaker, microphone, joystick) may also be provided.

The processor 1814 is responsible for managing the bus 1812 and general processing, including execution of software that may be stored on the computer-readable medium 1816 or the memory 1818. The software, when executed by the processor 1814, causes the processing system 1810 to perform the various functions described herein for any particular apparatus. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The various functions described herein may also be provided by the training module/app 1830, which may be implemented using the hardware, the software, or a combination of both the hardware and the software described herein. For example, the application described above that runs on a device like the device 112 and the device 162 that provides such functionality as displaying swing guides, interacting with swing templates, sending or receiving drawing files, communicating with a camera such as the camera 112, etc., may be implemented by the training module/app 1830, where the system 1800 is used to implement the device. As another example, the functionality related to the various aspects of the disclosure provided by a camera such as the camera 112 may be implemented by the training module/app 1830 where the system 800 implements the camera.

The computer-readable medium 1816 or the memory 1818 may also be used for storing data that is manipulated by the processor 1814 when executing software. In accordance with various aspects of the disclosed approach, data such as video, swing guides, swing templates, and swing template libraries may be stored in computer-readable medium 1816 and/or the memory 1818. For example, the computer-readable medium 1816 may be used to store the swing template library. The computer-readable medium 1816 may be used to implement the storage 432.

The computer-readable medium 1816 may be a non-transitory computer-readable medium such as a computer-readable storage medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. Although illustrated as residing in the processing system 1810, the computer-readable medium 1816 may reside externally to the processing system 1810, or distributed across multiple entities including the processing system 1810. The computer-readable medium 1816 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In accordance with various aspects of the disclosed approach, the memory 1818 may include a portion dedicated for use as a video buffer that my be used to store video received from a camera such as the camera 122. For example, the video buffer 432 of FIG. 4 may be implemented in the memory 1818. In one aspect of the disclosed approach, this video buffer may be implemented as a looping video buffer, which enables looping video capture. In general, looping video capture provides continuous video recording in a storage device with a fixed capacity; overwriting the beginning of a captured video segment to allow for new footage to be captured. A looping video buffer may be configured to store a video segment of a predetermined maximum length of time or size.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), a camera, or a device. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for providing a set of training guides for training a person on a live streaming video of the person comprising:
capturing at least one frame of the person from the live streaming video;
displaying the at least one frame of the person on a display;
detecting an interaction on the display by a user; and,
displaying a training guide based on the interaction, wherein the training guide is displayed as an overlay on the at least one frame on the display.
